(19) United States
(12) Patent Application Publication
(10) Pub. No.: US 2024/0118741 A1
(43) Pub. Date: Apr. 11, 2024

(54) POWER SOURCE MODULE, POWER DISTRIBUTION BOARD, AND SERVER SYSTEM APPLIED THE POWER SOURCE MODULE

(71) Applicant: Shenzhen Fulian Fugui Precision Industry Co., Ltd., Shenzhen (CN)

(72) Inventors: HE FENG, Shenzhen (CN); YING LI, Tianjin (CN); HUI-BO LIU, Shenzhen (CN)

(21) Appl. No.: 18/131,848

(22) Filed: Apr. 6, 2023

(30) Foreign Application Priority Data
Oct. 11, 2022 (CN) 202211238681.6

(51) Int. Cl. G06F 1/3296

(52) U.S. Cl. CPC G06F 1/3296

(57) ABSTRACT

A power source module for powering a motherboard comprises a rectifier circuit, a controlling unit, and a leakage protection circuit. The rectifier circuit electrically connected with the motherboard converts the input voltage into the first voltage configured for powering the motherboard. The controlling unit electrically connected with the motherboard outputs the control signals based on an operation state of the motherboard. The leakage protection circuit electrically connected with the controlling unit guides the control signals into a signal line before the motherboard being powered. The leakage protection circuit avoids the control signals to the component of the motherboard, and an operation time sequence of the component is not disturbed before being powered. A power distribution board and a server system are also disclosed.

### FIELD

The subject matter herein generally relates to power source system.

### BACKGROUND

A server system generally includes a power source module and a motherboard. The power source module receives an input voltage and convert the input voltage into an output voltage for powering the motherboard. The power source module further outputs control signals for indicating or controlling an operation state of the motherboard. Before the motherboard is powered, the control signals may be leaked to the motherboard, which cause an operation time sequence of a component on the motherboard to be disturbed and affects an operation of the server system.

There is room for improvement in the art.

### BRIEF DESCRIPTION OF THE DRAWINGS

Implementations of the present disclosure will now be described, by way of example only, with reference to the attached figures.

FIG. 1 is a diagram illustrating an embodiment of a server system according to the present disclosure.

FIG. 2 is a diagram illustrating a first embodiment of a leakage protection circuit of the server system of FIG. 1 according to the present disclosure.

FIG. 3 is a diagram illustrating a second embodiment of a leakage protection circuit of the server system of FIG. 1 according to the present disclosure.

### DETAILED DESCRIPTION

The present disclosure is described with reference to accompanying drawings and the embodiments. It will be understood that the specific embodiments described herein are merely part of all embodiments, not all the embodiments. Based on the embodiments of the present disclosure, it is understandable to a person skilled in the art, any other embodiments obtained by persons skilled in the art without creative effort shall all fall into the scope of the present disclosure. It will be understood that the specific embodiments described herein are merely some embodiments and not all.

It will be understood that, even though the flowchart shows a specific order, an order different from the specific order shown in the flowchart can be implemented. The method of the present disclosure can include one or more steps or actions for achieving the method. The steps or the actions in the method can be interchanged with one another without departing from the scope of the claims herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

Terms “first”, “second”, and the like used in the specification, the claims, and the accompanying drawings of the present disclosure are used to distinguish different objects rather than describe a particular order. A term “comprise” and its variations are intended to cover a non-exclusive inclusion. For example, a process, method, system, product, or apparatus including a series of steps or units is not limited to the listed steps or units, and may optionally include other steps or units that are not listed, or other steps or units inherent to the process, method, product, or device.

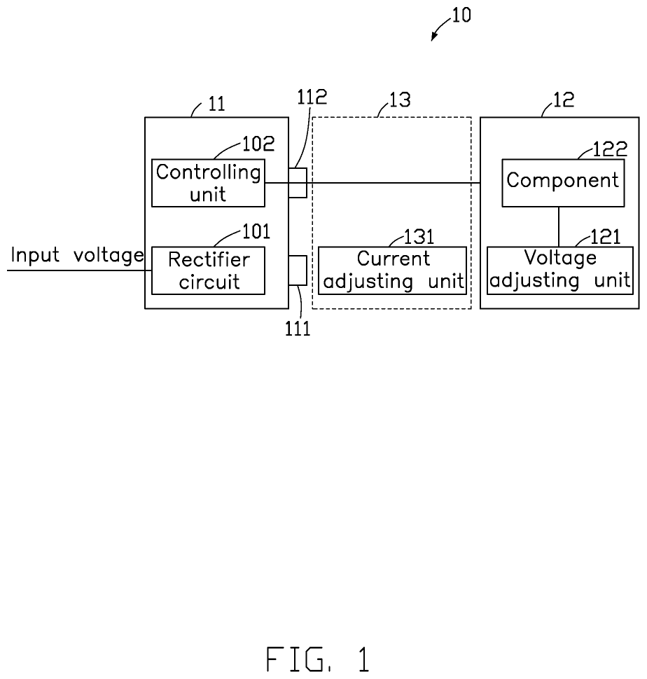

FIG. 1 shows a server system 10. The server system 10 includes a power source module 11 and a motherboard 12. The power source module 11 includes a rectifier circuit 101, a controlling unit 102, a first port 111 and a second port 112. The motherboard 12 includes a voltage adjusting module 121 and a component 122.

The power source module 11 is electrically connected with the motherboard 12. The power source module 11 provides powers to the motherboard 12. In detail, the rectifier circuit 101 receives an input voltage and converts the input voltage into a first voltage. The rectifier circuit 101 outputs the first voltage for powering the voltage adjusting unit 121 through the first port 111. In some embodiments, the power source module 11 can be a power supply unit (PSU). The input voltage can be provided by an external power source (not shown). The input voltage can be an 220V alternating voltage (AC), or can be 220V direct voltage (DC).

The voltage adjusting unit 121 is electrically connected with the component 122. The voltage adjusting unit 121 converts the first voltage outputted by the power source module 11 into a second voltage for powering the component 122. In some embodiments, the voltage adjusting unit 121 can be a voltage regulator (VR), and the second voltage can be 3.3V DC. The component 122 can be a center processing unit (CPU), a chipset, a disk driver manger, an expansion slot, a memory, and a port, and the like.

The controlling unit 102 is electrically connected with the component 122. The controlling unit 102 outputs control signals based on an operation state of the motherboard 12 for controlling operations of the motherboard 12. For example, the controlling unit 102 outputs an alert signal while a temperature of the motherboard 12 exceeds a predetermined value, for prompting an anormal temperature. Or the controlling unit 102 outputs a power management bus (PMBus) signal in response to a communication request of the motherboard 12, for communicating with the motherboard 12.

In some embodiments, a power distribution board (PDB) 13 is provided and is electrically connected between the power source module 11 and the motherboard 12. The PDB 13 adjusts a current outputted by the power source module 11, which ensures the power source module 11 to power the motherboard 12 stably and safely. In detail, the PDB 13 includes a current adjusting unit 131. The current adjusting unit 131 is electrically connected between the rectifier circuit 101 and the voltage adjusting unit 121. The current adjusting unit 131 adjusts a current outputted by the rectifier circuit 101 and ensures the power source module 11 to power the motherboard 12 stably and safely.

While the power source module 11 being powered on, the voltage adjusting unit 121 converts the first voltage outputted by the power source module 11 into the second voltage, the control signals inside the power source module 11 may be provided to the component 122 through the second port 112 before outputting the second voltage. Without receiving the second voltage, an operation time sequence of the component 122 may be disturbed by the control signals.

Based on the problems, a leakage protection circuit 100 is provided for decreasing a risk of the operation time sequence of the component 122 to be disturbed and for avoiding the control signals to be provided to the component 122 before the component 122 receives the second voltage.

### First Embodiment

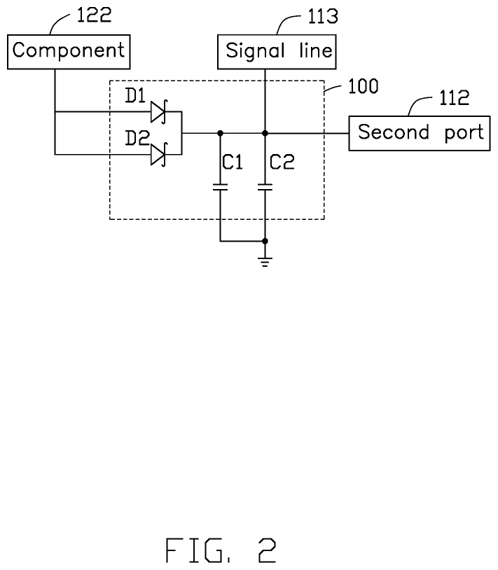

FIG. 2 shows a first embodiment of the leakage protection circuit 100. The leakage protection circuit 100 is disposed in the power source module 11. The leakage protection circuit 100 avoids the control signals to input to the motherboard 12 for decreasing an impact of the control signals on the operation time sequence of the component 122 on the motherboard 12. The control signals are outputted through the second port 112 controlled by the controlling unit 102. In detail, the power source module 11 includes a signal line 123, the leakage protection circuit 100 guides the control signals to the signal line 123 before the component 122 being powered, thus the control signals are avoided to be flowed into the component 122. The signal line 123 may be a P3V3_STBY_PSU signal line.

The leakage protection circuit 100 includes a first diode D1, a second diode D2, a first capacitor C1, and a second capacitor C2. An anode of the first diode D1 is electrically connected with the second port 112 and an anode of the second diode D2, and a cathode of the first diode D1 is electrically connected with a cathode of the second diode D2, a terminal of the first capacitor C1, a terminal of the second capacitor C2, and the signal line 123. The signal line 123 is electrically connected with the power source module 11. The cathode of the first diode D1 receives the control signals from the power source module 11. Another terminal of the first capacitor C1 is electrically connected with another terminal of the second capacitor C2 and is grounded.

In some embodiments, the first capacitor C1 and the second capacitor C2 are bypass capacitors. The first capacitor C1 and the second capacitor C2 filter the control signals for adjusting the current value of the control signals.

Due to a unilateral conductivity of the first diode D1 and the second diode D2, the control signals of the power source module 11 fail to provide to the component 122 through the first diode D1 and the second diode D2 and is transmitted to the signal line 123. Thus, the leakage protection circuit 100 avoids the control signals to provide to the component 122, and the operation time sequence of the component 122 is not disturbed before being powered.

### Second Embodiment

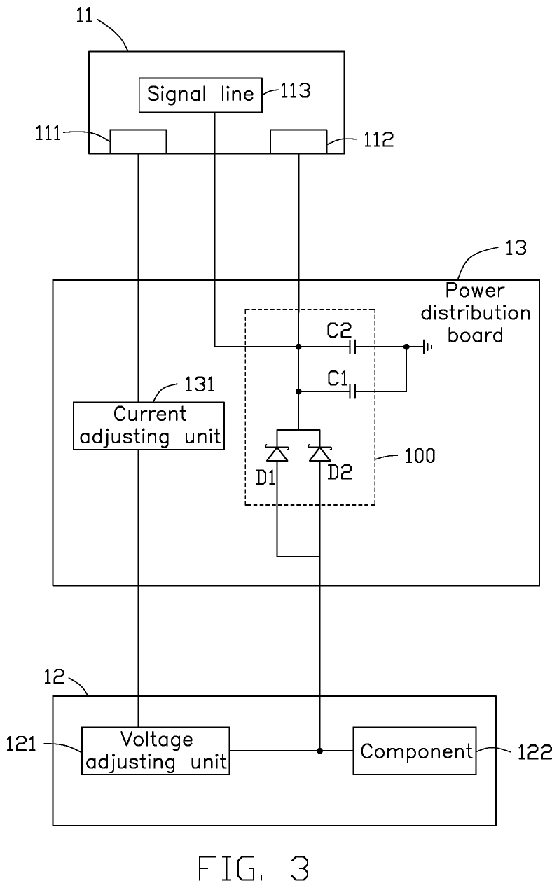

FIG. 3 shows a second embodiment of the leakage protection circuit 100. The structure of the leakage protection circuit 100 in FIG. 3 is similar to the structure of the leakage protection circuit 100 in FIG. 2, the difference is position of the leakage protection circuit 100. In FIG. 3, the leakage protection circuit 100 is disposed on the PDB 13.

Due to a unilateral conductivity of the first diode D1 and the second diode D2, the control signals of the power source module 11 fail to provide to the component 122 through the first diode D1 and the second diode D2 and is transmitted to the signal line 123. Thus, the leakage protection circuit 100 avoids the control signals to provide to the component 122, and the operation time sequence of the component 122 is not disturbed before being powered.

The power source module 11, the PDB 13, and the server system 100 of the present disclosure can avoids the control signals to provide to the component 122, and the operation time sequence of the component 122 is not disturbed before being powered.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A power source module configured for powering a motherboard, the power source module comprises:
a rectifier circuit electrically connected with the motherboard; the rectifier circuit configured to convert an input voltage into a first voltage configured for powering the motherboard;
a controlling unit electrically connected with the motherboard; the controlling unit configured to output control signals based on an operation state of the motherboard; and
a leakage protection circuit electrically connected with the controlling unit; the leakage protection circuit configured to guide the control signals into a signal line before the motherboard being powered by the rectifier circuit.

2. The power source module of claim 1, wherein the power source module further comprises a first port and a second port; the rectifier circuit outputs the first voltage configured for powering the motherboard through the first port; the controlling unit outputs the control signals to the motherboard through the second port.

3. The power source module of claim 1, wherein the leakage protection circuit comprises at least one diode; an anode of the at least one diode is electrically connected with the motherboard, and a cathode of the at least one diode is electrically connected with the controlling unit; the at least one diode guides the control signals to the signal line.

4. The power source module of claim 2, wherein the leakage protection circuit comprises at least one capacitor; a terminal of the at least one capacitor is electrically connected with the controlling unit, and another terminal of the at least one capacitor is grounded; the at least one capacitor filters the control signals.

5. The power source module of claim 3, wherein the anode of the at least one diode is further electrically connected with the signal line; and the signal line is electrically connected between the power source module and the anode of the at least one diode.

6. A power distribution board (PDB) comprises:
a current adjusting unit electrically connected between a power source module and a motherboard; the current adjusting unit configured to adjust a current outputted by the power source for controlling electric power provided to the motherboard, the electric power being provided by the power source module; and
a leakage protection circuit electrically connected with the power source module and the motherboard; the leakage protection circuit configured to guide control signals from the power source module into a signal line before the motherboard being powered by the current adjusting unit.

7. The PDB of claim 6, wherein the leakage protection circuit comprises at least one diode; an anode of the at least one diode is electrically connected with the motherboard, and a cathode of the at least one diode is electrically connected with a controlling unit in the power source module; the at least one diode guides the control signals to the signal line.

8. The PDB of claim 6, wherein the leakage protection circuit comprises at least one capacitor; a terminal of the at least one capacitor is electrically connected with a controlling unit in the power source module, and another terminal of the at least one capacitor is grounded; the at least one capacitor filters the control signals.

9. The PDB of claim 6, wherein the power source module comprises a rectifier circuit; the rectifier circuit is electrically connected with the motherboard; the rectifier circuit converts an input voltage into a first voltage configured for powering the motherboard; the controlling unit outputs the control signals based on an operation state of the motherboard.

10. The PDB of claim 9, wherein the power source module further comprises a first port and a second port; the rectifier circuit outputs the first voltage configured for powering the motherboard through the first port; the controlling unit outputs the control signals to the motherboard through the second port.

11. A server system comprises:
a motherboard with a voltage adjusting unit and a component; the voltage adjusting unit electrically connected with the component; the voltage adjusting unit configured to receive a first voltage and convert the first voltage into a second voltage configured for powering the component;
a power source module configured to convert an input voltage into the first voltage configured for powering the motherboard and output control signals based on an operation state of the motherboard; and
a leakage protection circuit electrically connected with the power source module and the motherboard; the leakage protection circuit configured to guide the control signals into a signal line before the motherboard being powered by the current adjusting unit.

12. The server system of claim 11, wherein the leakage protection circuit is disposed in the power source module; the power source module comprises a rectifier circuit and a controlling unit; the rectifier circuit is electrically connected with the motherboard; the rectifier circuit converts the input voltage into the first voltage configured for powering the motherboard; the controlling unit outputs the control signals based on an operation state of the motherboard; the leakage protection circuit is electrically connected with the controlling unit.

13. The server system of claim 12, wherein the power source module further comprises a first port and a second port; the rectifier circuit outputs the first voltage configured for powering the motherboard through the first port; the controlling unit outputs the control signals to the motherboard through the second port.

14. The server system of claim 11, wherein the leakage protection circuit is disposed on a power distribution board (PDB); the PDB is electrically connected between the power source module and the motherboard.

15. The server system of claim 14, wherein the power source module comprises a rectifier circuit and a controlling unit; the rectifier circuit is electrically connected with the motherboard; the rectifier circuit converts the input voltage into the first voltage configured for powering the motherboard; the controlling unit outputs the control signals based on an operation state of the motherboard; the leakage protection circuit is electrically connected with the controlling unit.

16. The server system of claim 15, wherein the power source module further comprises a first port and a second port; the rectifier circuit outputs the first voltage configured for powering the motherboard through the first port; the controlling unit outputs the control signals to the motherboard through the second port.

17. The server system of claim 11, wherein the leakage protection circuit comprises at least one diode; an anode of the at least one diode is electrically connected with the motherboard, and a cathode of the at least one diode is electrically connected with the controlling unit; the at least one diode guides the control signals to the signal line.

18. The server system of claim 11, wherein the leakage protection circuit comprises at least one capacitor; a terminal of the at least one capacitor is electrically connected with a controlling unit in the power source module, and another terminal of the at least one capacitor is grounded; the at least one capacitor filters the control signals.
